(19) United States
(12) Patent Application Publication
(10) Pub. No.: US 2024/0061982 A1
(43) Pub. Date: Feb. 22, 2024

(54) PIPE BLOCKAGE PREDICTION METHODS

(71) Applicant: SAMSUNG ELECTRONICS CO., LTD., Suwon-si (KR)

(72) Inventors: Hanahchim CHOUNG, Suwon-si (KR); Seokryul KIM, Suwon-si (KR); Sunghyup KIM, Suwon-si (KR)

(73) Assignee: SAMSUNG ELECTRONICS CO., LTD., Suwon-si (KR)

(21) Appl. No.: 18/227,587

(22) Filed: Jul. 28, 2023

(30) Foreign Application Priority Data
Aug. 18, 2022 (KR) 10-2022-0103481

(51) Int. Cl. G06F 30/28

(52) U.S. Cl. CPC G06F 30/28

(57) ABSTRACT

A pipe blockage prediction method includes generating a first simulation model by performing a first simulation based on pipe information and fluid information including a flow rate and pressure of a fluid in a pipe, generating a second simulation model by performing a second simulation that is different from the first simulation, based on the pipe information and the fluid information, generating a third simulation model through machine learning, based on the first simulation model and the second simulation model, and predicting pipe blockage for each of a plurality of sections of the pipe based on the third simulation model.

### CROSS-REFERENCE TO RELATED APPLICATION

This application claims priority to Korean Patent Application No. 10-2022-0103481, filed on Aug. 18, 2022, in the Korean Intellectual Property Office, the disclosure of which is incorporated by reference herein in its entirety.

### BACKGROUND

The disclosure relates to a pipe blockage prediction method.

In general, flow analysis of fluids, such as air, oil, and water, may be very important in various industrial fields, such as petrochemical plants and power plants, for designing plants and solving issues in work processes.

This fluid flow analysis refers to understanding the interaction between the fluid, gas, etc., and the surface defined by the boundary condition around the part to be analyzed (e.g., a pipe), and the change in flow and related characteristics. Computational fluid dynamics (CFD) may be used to reproduce the flow of heat and fluid through computational operations, and by reproducing the analysis of heat and fluid motion in the past, which was only based on experiments, through effective numerical analysis in a short time with the development of computers. this has resulted in significant savings in time and cost.

However, in relation to the CFD analysis technique used to predict the flow of heat and fluid in the past, there is an issue that the CFD analysis technique is difficult to utilize in the construction of a digital twin that requires real-time prediction and as the size of the analysis target increases, the amount of computations increases exponentially, requiring enormous computational resources and taking a long time to analyze.

### SUMMARY

The disclosure provides a pipe blockage prediction method for rapidly and accurately predicting a fluid flow phenomenon.

According to an aspect of an embodiment, a pipe blockage prediction method includes: generating a first simulation model by performing a first simulation based on pipe information and fluid information comprising a flow rate and pressure of a fluid in a pipe; generating a second simulation model by performing a second simulation that is different from the first simulation, based on the pipe information and the fluid information; generating a third simulation model through machine learning, based on the first simulation model and the second simulation model; and predicting pipe blockage for each of a plurality of sections of the pipe based on the third simulation model.

According to an aspect of an embodiment, a pipe blockage prediction method includes: generating a first pressure value for each of a plurality of pipes using a three-dimensional computational fluid dynamics (CFD) analysis method based on pipe information and fluid information; generating a section pressure for each section of the plurality of pipes based on the pipe information and the fluid information; generating a second pressure value of each of the plurality of pipes based on the section pressure; generating a section diameter for each section of the plurality of pipes based on the first pressure value and the second pressure value; setting the section diameter and the second pressure value as parameters, and generating a pipe prediction model through machine learning; and generating a fluid analysis map in a three-dimensional drawing based on the pipe prediction model.

According to an aspect of an embodiment, a pipe blockage prediction method includes: generating a first simulation model by performing a first simulation based on pipe information and fluid information comprising flow rate information; obtaining a second simulation model by performing a second simulation that is different from the first simulation on the pipe information and the fluid information; generating a third simulation model using a machine learning model based on the first simulation model and the second simulation model; generating a fluid analysis map displaying a pipe diameter and a pipe pressure for each section of the plurality of pipes in a three-dimensional drawing using the third simulation model; and predicting pipe blockage for each section of the plurality of pipes based on the fluid analysis map, wherein the first simulation model predicts a first pressure value corresponding to pipe pressure in an end portion of each of the plurality of pipes, wherein the second simulation model predicts a second pressure value corresponding to a section pressure for each section of the plurality of pipes and a pressure of the end portion of each of the plurality of pipes, wherein, when a difference between the first pressure value and the second pressure value is less than or equal to a preset threshold, the third simulation model is generated.

### BRIEF DESCRIPTION OF THE DRAWINGS

The above and other aspects and features will be more apparent from the following description of example embodiments taken in conjunction with the accompanying drawings in which:

FIG. 1 is a block diagram illustrating a fluid analysis system according to an embodiment;

FIG. 2 is a flowchart schematically showing a process of a pipe blockage prediction method according to an embodiment;

FIG. 3 is a flowchart schematically illustrating a process of a method of generating a second simulation model, according to an embodiment;

FIG. 4 is a flowchart schematically illustrating a process of a method of generating a third simulation model, according to an embodiment;

FIG. 5 is a flowchart schematically illustrating a process of a pipe blockage prediction method using a third simulation model according to an embodiment;

FIG. 6 is a view illustrating a portion of a plurality of pipes according to embodiments;

FIG. 7 is a graph showing the consistency of pressure predicted by the pipe blockage prediction method for the pipe of FIG. 5;

FIG. 8 is a graph showing the consistency of pipe blockage predicted by the pipe blockage prediction method for the pipe of FIG. 5;

FIG. 9 is a diagram illustrating a plurality of pipes according to embodiments;

FIGS. 10 to 12 are diagrams illustrating a fluid analysis map for the pipe of FIG. 8;

FIG. 12 is a view showing the consistency with respect to the pressure of each of the first simulation model and the third simulation model for the pipe of FIG. 8; and

FIG. 13 is a graph showing the consistency of pressure predicted by the pipe blockage prediction method for a plurality of pipes of FIG. 9.

### DETAILED DESCRIPTION OF THE EMBODIMENTS

Example embodiments will be described more fully with reference to the accompanying drawings, in which example embodiments are shown. Embodiments described herein are provided as examples, and thus, the present disclosure is not limited thereto, and may be realized in various other forms. Each example embodiment provided in the following description is not excluded from being associated with one or more features of another example or another example embodiment also provided herein or not provided herein but consistent with the present disclosure. It will be understood that when an element or layer is referred to as being “on,” “connected to” or “coupled to” another element or layer, it can be directly on, connected or coupled to the other element or layer, or intervening elements or layers may be present. By contrast, when an element is referred to as being “directly on,” “directly connected to” or “directly coupled to” another element or layer, there are no intervening elements or layers present. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c. The same reference numerals are used for the same components in the drawings, and duplicate descriptions thereof are omitted.

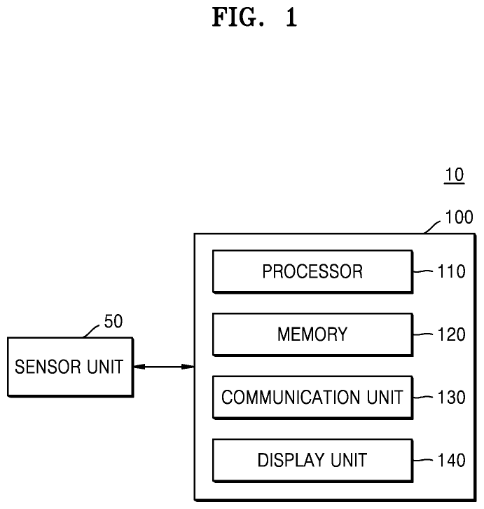

FIG. 1 is a conceptual diagram illustrating a fluid analysis system 10 according to an embodiment.

Referring to FIG. 1, the fluid analysis system 10 may include a sensor unit 50 and a fluid analysis device 100. Here, the fluid analysis device 100 may include a processor 110, a memory 120, a communication unit 130, and a display unit 140.

The processor 110 may execute, for example, software or a program to perform various data processing or operations. The data processing or calculation may include an operation for specifying and displaying a location where the pipe is clogged in a simulation model for a fluid flowing in the pipe. The processor 110 may load the received command or data into a memory (e.g., volatile memory) based on a user input or the like, process the stored command or data, and store the resulting data in a memory (e.g., non-volatile memory). In an embodiment, the processor may include a central processing unit (CPU), an application processor, a modem-integrated application processor, a system-on-chip (SoC), an integrated circuit, or the like. An embodiment may include a special purpose computer and the special purpose computer may include at least one processor configured to control functions based on computer programs stored in a memory or memory module.

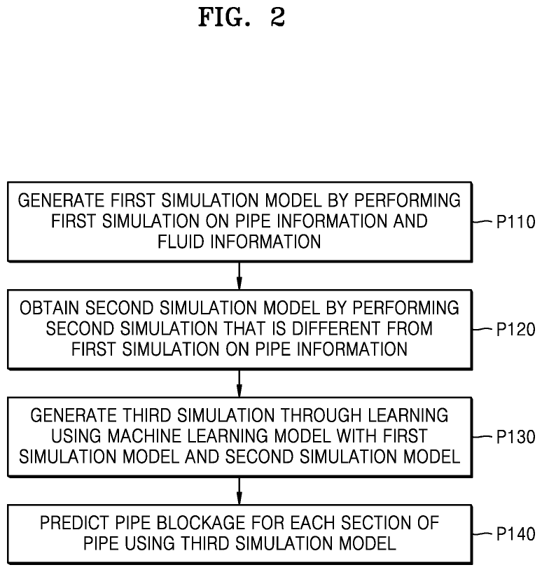

In example embodiments, the processor 110 may perform first to third simulations described below with reference to FIGS. 2 to 4. The first to third simulations may be simulations of predicting blockage of a pipe by a fluid flowing in the pipe. The processor 110 may predict the pipe pressure of the pipe after a semiconductor process, the amount of slurry accumulated in the pipe, the pipe diameter, and the like through the first to third simulations.

Also, the processor 110 may refer to a data processing device embedded in hardware. As an example of a data processing device embedded in hardware as described above, processing devices may include a microprocessor, a Central Processing Unit (CPU), a processor core, a multiprocessor, an Application-Specific Integrated Circuit (ASIC), a Field Programmable Gate Array (FPGA), and the like, but the scope of the embodiments are not limited thereto.

The memory 120 may store various pieces of data used by the processor 110. The data may include, for example, input data or output data for software, a program, and instructions related thereto. The memory 120 may include a volatile memory or a non-volatile memory.

According to an embodiment, the memory 120 may store a program for specifying and displaying the blocked position of the pipe. The program may store a plurality of instructions for specifying and displaying a blocked location of a pipe. In example embodiments, the memory 120 may store piping information including data, such as the shape, length, and diameter of the pipe, and flow information including data, such as pressure, density, and flow rate for the fluid flowing in the pipe. The processor 110 may calculate a pipe diameter based on the pipe information and the flow rate information, and predict pipe blockage. The calculated pipe diameter may be a pipe diameter that is narrowed due to the presence of slurry. For example, in an example embodiment, the calculated pipe diameter may be a diameter of the pipe through which fluid flows and which may be higher or lower depending upon an amount of slurry or a predicted amount of slurry.

The memory 120 may include, for example, at least one type of storage medium of flash memory type, hard disk type, random access memory (RAM), static random access memory (SRAM), read-only memory (ROM), magnetic memory, magnetic disk, and optical disc.

The communication unit 130 may receive a pressure value measured from the sensor unit 50 in real time. The communication unit 130 may transmit the received pressure value to the processor 110. Also, the communication unit 130 may communicate with an external device (e.g., a user terminal or a server). The communication unit 130 may transmit/receive data for specifying and displaying a blocked position of a pipe to/from an external device.

The display unit 140 may visually provide information to the outside of the fluid analysis device 100. For example, the display unit 140 may include a display. The display unit 140 may display data generated by the processor 110 in a three-dimensional drawing. Also, the display unit 140 may display the fluid analysis map generated by the processor 110.

The sensor unit 50 may be a pressure sensor. The sensor unit 50 may be disposed at the end portion of the pipe. The sensor unit 50 may measure the pressure of the fluid flowing through the pipe. The sensor unit 50 may transmit the measured pressure to the communication unit 130 of the fluid analysis device 100.

FIG. 2 is a flowchart schematically showing a process of a pipe blockage prediction method according to an embodiment.

Referring to FIG. 2, in the pipe blockage prediction method according to an embodiment, a first simulation is first performed on pipe information and fluid information to generate a first simulation model in operation P110. Here, the pipe information may include shape information of the pipe. The shape information of the pipe may be information including at least one of a straight pipe, an elbow, a T-tube, a reducer, and an orifice. In addition, the pipe information may include a diameter, a length, a friction coefficient of a pipe, and the number of pipes. The fluid information may include at least one of density, flow rate, flow rate, temperature, dryness, and pressure of a fluid flowing in the pipe including the different shapes or sections of a pipe. The pipe information and the fluid information may be information received from an external device or an external server, or an input value input through a user interface. In an embodiment, the pipe information and the fluid information may be known information that has been previously measured, calculated or otherwise determined and may be information from a database or other sources.

The fluid flowing in the pipe may be a fluid introduced from a chamber. The chamber may be a space in which a semiconductor process is performed. After the semiconductor process in the chamber, the fluid may be introduced into the pipe. The semiconductor process may include various processes. For example, the semiconductor process may include an exposure process, a developing process, an etching process, and the like.

The first simulation may be a simulation for obtaining the pressure of the fluid in the pipe by the shape of the pipe and the flow rate of the fluid, the amount of slurry formed in the pipe, and the like. The first simulation model generated by performing the first simulation may predict the slurry formed in the actual pipe, the pressure of the fluid, the diameter of the pipe narrowed due to the slurry, and the like by reflecting the pipe information and the fluid information.

Referring to FIGS. 1 and 2, the first simulation may be a simulation of generating a first pressure value of the fluid in the pipe using a three-dimensional computational fluid dynamics (CFD) analysis method. The CFD analysis method refers to the simulation of fluid motion analysis through a computer. The CFD model may manage and simulate the fluid flow and free surface movement of the target system by predicting how the fluid moves in the pipe. However, in the pipe blockage prediction method of this embodiment, the first simulation is not limited to a CFD analysis method.

The first pressure value may correspond to a pressure value of the fluid measured at an end portion of the pipe with respect to the fluid flowing through the pipe. Also, the first pressure value may correspond to a pressure value measured by the sensor unit 50 disposed on the end portion of the pipe. That is, the first pressure value may correspond to a value assuming the pressure of the fluid in the end portion of the pipe based on the pipe information and the fluid information.

According to another embodiment, instead of operation P110, a pressure value may be obtained from the sensor unit 50 disposed in the end portion of the pipe, and the first simulation model may be replaced with the pressure value obtained from the sensor unit 50. Thereafter, the first simulation model used in operations P120 to P140 may be replaced with the pressure value obtained from the sensor unit 50. That is, according to another embodiment, it is possible to predict pipe blockage based on the pressure value obtained in real time from the sensor unit 50.

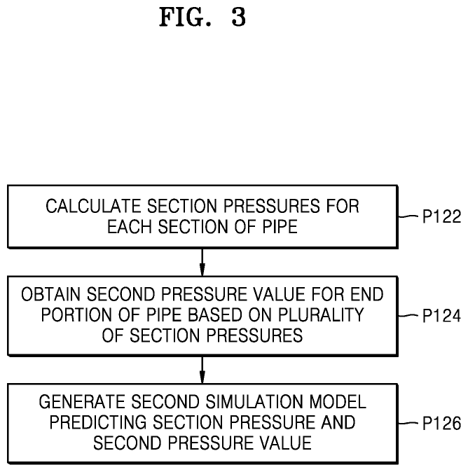

After the first simulation model is generated through the first simulation, the second simulation model may be obtained in operation P120 by performing a second simulation that is different from the first simulation. The second simulation is performed on the pipe information and the fluid information in operation P120. The second simulation may be a simulation of predicting a loss due to friction or a head loss when a fluid flows in a pipe of a preset length, based on the pipe information and the fluid information. The second simulation may be a simulation performed based on a Darcy-Weisbach equation. The second simulation model may include a second pressure value for the end portion of the pipe. Here, the second pressure value may be a pressure value of the fluid predicted at the end portion of the pipe based on the pipe information and the fluid information. The second simulation and the second simulation model are described in detail with reference to FIG. 3.

FIG. 3 is a flowchart schematically illustrating a process of a method of generating a second simulation model according to an embodiment.

Referring to FIG. 3, in the method of obtaining the second simulation model by performing the second simulation in operation P120, a plurality of section pressures for each section of the pipe may be calculated by first performing the second simulation in operation P122. Here, the second simulation may be a simulation of generating a plurality of section pressures for each section of the pipe and a second pressure value for the end portion of the pipe, unlike the first simulation. That is, in an example embodiment, the second simulation may be different than the first simulation.

The Darcy-Weiss Bach equation may be Equation 1 below.

$$Δ p = L \times {f}_{D} \times \frac{p}{2} \times \frac{{v}^{2}}{D} \qquad [ Equation 1 ]$$

The second simulation follows Equation 1, and in Equation 1 above, Δp is the pressure change of the fluid, L is the pipe length, f_{D} is the pipe friction coefficient, ρ is the density of the fluid, v is the flow rate, and D is the pipe diameter.

The flow rate of the fluid included in the fluid information may include an inflow flow rate introduced into the pipe from the chamber and an outflow flow rate discharged from the pipe. In example embodiments, the flow rate of the fluid may be a value predicted through the first simulation. Through the second simulation using Equation 1, the pressure of the fluid for each section in the pipe may be predicted.

After predicting the pressure of the fluid for a plurality of sections in the pipe, a second pressure value for the pipe end portion may be obtained based on the plurality of section pressures in operation P124. The second pressure value may correspond to the pressure of the fluid in the end portion of the pipe. In example embodiments, the second pressure value may be calculated using Equation 1 based on the plurality of section pressures. That is, the second pressure value may be calculated in the same manner as the method of obtaining the plurality of section pressures.

Thereafter, a second simulation model for predicting the section pressure and the second pressure value may be generated in operation p126. The second simulation model may be a simulation model in which the pressure value of the fluid is predicted for each section of the pipe.

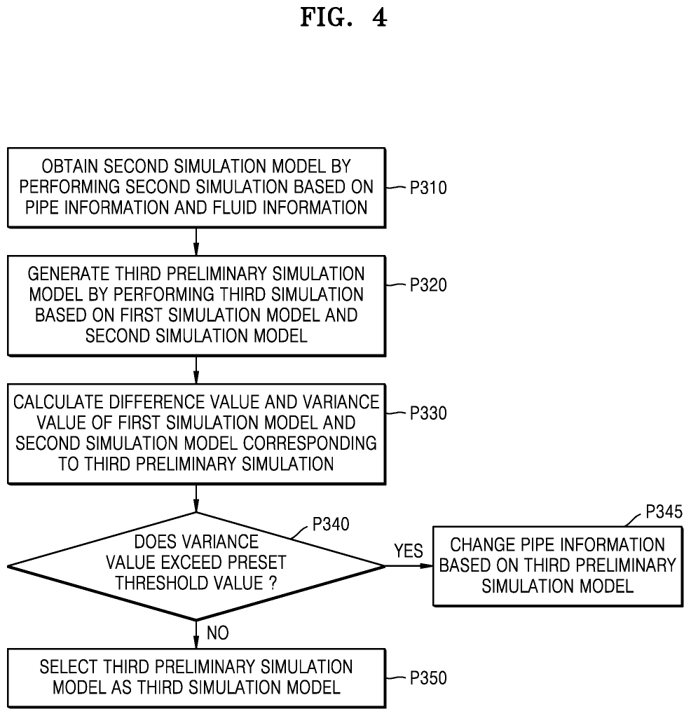

Again, to explain the third simulation, referring to FIG. 2, after acquiring the second simulation model, a third simulation model may be generated through machine learning using the first simulation model and the second simulation model in operation P130. The machine learning may be performed using a neural network, a support vector machine (SVM), a multi-layer perception (MLP), and deep learning. Hereinafter, a method of generating the third simulation model is described in detail with reference to FIG. 4.

FIG. 4 is a flowchart schematically illustrating a process of a method of generating a third simulation model, according to an embodiment.

Referring to FIG. 4, a second simulation model may be obtained by performing a second simulation on the pipe information and the fluid information in operation P310. The operation of obtaining of the second simulation model in operation P310 is the same as the operation of the description part of the method of obtaining the second simulation model of FIG. 3 in operation P120.

According to an embodiment, after obtaining the second simulation model, a third simulation may be performed based on the first simulation model and the second simulation model to generate a third preliminary simulation model in operation P320. Here, generating the third simulation model may include performing a third simulation based on the first simulation model and the second simulation model.

The third simulation may be a simulation of predicting the diameter and pressure for each section of the pipe using an optimizer based on the first simulation model and the second simulation model. The optimizer may be a stochastic gradient descent (SGD) algorithm. A third simulation model to be described below may be any one of the third preliminary simulation models selected under a preset condition from among the third preliminary simulation models.

The SGD algorithm may be represented by Equation 2 below.

$${R}_{N + 1} = {R}_{N} - α \frac{d v}{\sqrt{d m}} \qquad [ Equation 2 ]$$

$$α = Learning rate = 1 \times {10}^{- 3}$$

$$d m = 0.9 * d m + 0.1 ∇ J$$

$$dv = 0.009 * d v + 0.001 ∇ {J}^{2}$$

$$Cost Function : J = \sum {( {P}_{s} - {P}_{c} )}^{2}$$

The third simulation follows Equation 2, and in Equation 2, R_{N+1} may be a first diameter, R_{N} may be a second diameter, Pₛ may be a first pressure value of the first simulation model, and P_{c} may be a second pressure value of the second simulation model. dm may indicate a primary momentum, dv may indicate a secondary momentum, and J may indicate an error between the first pressure value and the second pressure value.

The first diameter and the second diameter may be section diameters for each section of the plurality of pipes. The first diameter and the second diameter may be values predicted with respect to a pipe diameter for the one same section. In example embodiments, the second diameter may have a greater value than the first diameter. In example embodiments, the second diameter may have a smaller value than the first diameter.

Specifically, in embodiments, the first diameter may be the diameter of the pipe before the slurry is formed, and the second diameter may be the diameter of the narrowed pipe predicted by the slurry formation in the pipe. In embodiments, the first diameter may be the diameter of the narrowed pipe predicted to form a slurry in the pipe, and the second diameter may be greater than the first diameter because it is predicted that less slurry is formed than the pipe having the first diameter.

When the third preliminary simulation is generated by the third simulation performed first, the first diameter is the diameter of the pipe in a state in which the slurry in the pipe is not formed, and the second diameter is predicted by Equation 2, and may be a diameter of a pipe in a state in which the slurry is formed. The diameter of the pipe predicted by the third preliminary simulation model may be the second diameter. That is, the first diameter may be an input value, and the second diameter may be an output value output to the third preliminary simulation model. In addition, the second diameter may include a section diameter for each section of each of the plurality of pipes.

Using Equation 2, the diameters of the pipe may be predicted differently for each section of the pipe. Any one of the set diameters of the pipe and the other one of the set diameters of the pipe may have the same value.

A third simulation model may be generated through machine learning with respect to the generated third preliminary simulation model. Specifically, a difference value and a variance value between the first simulation model and the second simulation model corresponding to the third preliminary simulation model may be calculated in operation P330. Specifically, the difference value and the variance value between the first simulation model and the second simulation model may refer to the difference value and the variance value between the first pressure value of the first simulation model and the second pressure value of the second simulation model. The difference value and the variance value may be calculated using a cost function in Equation 2 above.

After calculating the difference value and the variance value, it may be determined whether the third preliminary simulation model satisfies a preset condition. Whether the condition is satisfied may be determined according to whether the variance value of the third preliminary simulation exceeds a preset threshold in operation P340. Here, the variance value of the third preliminary simulation may refer to a variance value calculated based on the first simulation model and the second simulation model corresponding to the third preliminary simulation model.

When the variance value exceeds a preset threshold (YES), it may be determined that the third preliminary simulation model does not satisfy the condition. When the above condition is not satisfied, the corresponding third preliminary simulation model may be excluded from the target of the third simulation model. The third preliminary simulation model may correspond to a model that does not satisfy the above condition. That is, in an example embodiment, when the variance value exceeds a threshold (YES in the flowchart of FIG. 4) the condition is not satisfied and the third preliminary simulation model is not selected as the third simulation model.

When it is determined that the above condition is not satisfied, machine learning may be performed again. The third preliminary simulation model may be repeatedly generated, and the learning may be performed in a direction of minimizing a difference between the first pressure value of the first simulation model and the second pressure value of the second simulation model. That is, by performing the machine learning, it is possible to obtain a third simulation model that minimizes a difference between the first pressure value and the second pressure value among the third preliminary simulation models.

Specifically, the learning using the machine learning model may first change the pipe information based on the third preliminary simulation model in operation P345. Next, the diameter of the pipe included in the pipe information may be changed to the predicted pipe diameter (e.g., the second diameter or RN+1 of Equation 2) of the third preliminary simulation model. Next, returning to the operation of acquiring the second simulation model, a second simulation may be performed based on the changed pipe information and fluid information to newly generate a second simulation model. Using such a new second simulation model, a third preliminary simulation model through the third simulation may be regenerated.

When the variance value is equal to or less than a preset threshold value (NO in the flowchart of FIG. 4), the third preliminary simulation model may be selected as the third simulation model in operation P350. The third simulation model may be referred to as a pipe prediction model. The generated third simulation model may predict data on the diameter, pressure, and mass of the slurry formed from the fluid for each pipe section for a plurality of pipes. That is, in an example embodiment, when the variance value does not exceed a threshold (NO in the flowchart of FIG. 4) the condition is satisfied and the third preliminary simulation model is selected as the third simulation model.

Also, as described with reference to FIG. 1, according to another embodiment, instead of generating the first simulation model, a pressure value is obtained from the sensor unit 50 disposed on the end portion of the pipe, and the first simulation model may be replaced with the pressure value obtained from the sensor unit 50. Thereafter, the first simulation model used in operations P310 to P350 may be replaced with the pressure value obtained from the sensor unit 50.

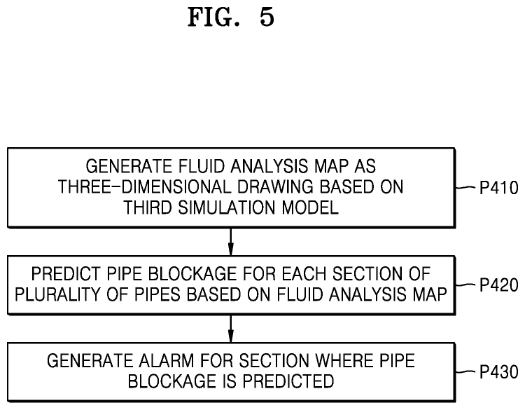

FIG. 5 is a flowchart schematically illustrating a process of a pipe blockage prediction method using a third simulation model according to an embodiment.

Referring to FIG. 5, a fluid analysis map may be generated in a three-dimensional drawing based on the third simulation model in operation P410. The fluid analysis map may be a three-dimensional drawing in which the pressure of the fluid, the amount of accumulated slurry, the diameter of the pipe, the flow rate, etc. are indicated for each section of the plurality of pipes. Through the fluid analysis map, it is possible to determine the flow of the fluid in the pipe. The diameter of the pipe may be an average diameter value with respect to the area of the flow path in the pipe excluding the accumulated slurry.

After generating the fluid analysis map, it is possible to predict pipe blockage for each section of a plurality of pipes based on the fluid analysis map in operation P420. The blockage of the pipe for each section of the pipe may refer to a state in which the fluid may not flow normally due to the slurry accumulated in the pipe. In embodiments, the predicted pipe blockage may be a case in which the amount of slurry accumulated in the pipe is 25% to 35% of the area of the corresponding section. In embodiments, the predicted pipe blockage may be a case in which the diameter of the pipe as narrowed by having slurry is 75% or less of the diameter of the pipe without any narrowing due to slurry. In embodiments, when the diameter of the pipe for each section is 70 percent or less of the diameter of the pipe on which the slurry is not formed, it may be determined that the pipe for each section is clogged. For example, if the pipe diameter in a section is narrowed by 30 percent or more due to slurry, the section of the pipe may be determined to be clogged. Embodiments are not limited thereto and the percentage at which a section is determined to be clogged may vary in other embodiments.

After predicting the pipe blockage, it is possible to generate an alarm for the section in which the pipe blockage is predicted in operation P430. The section in which the pipe blockage is predicted may be at least one of a plurality of sections of the pipe. The alarm may be an alarm requesting maintenance for a pipe. The alarm may be transmitted to an external device through the communication unit 130 of FIG. 1.

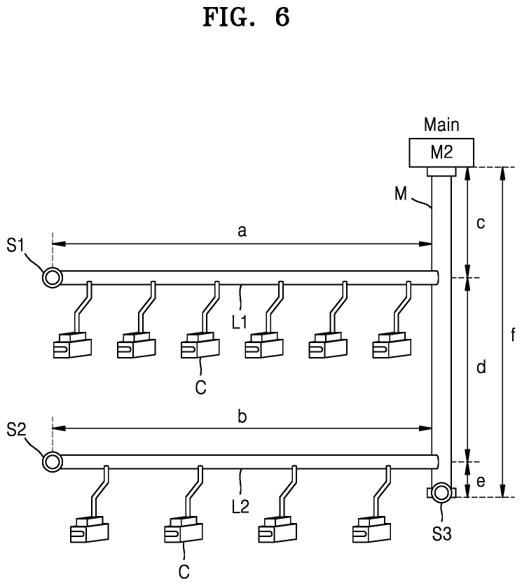

FIG. 6 is a view illustrating a portion of a plurality of pipes according to embodiments.

Referring to FIG. 6, some of the plurality of pipes were set virtually in order to implement the pipe blockage prediction method. Here, the plurality of pipes may include a first pipe L1, a second pipe L2, and a main pipe M. The first pipe L1 and the second pipe L2 may introduce a fluid after the semiconductor process from the plurality of chambers C. The first sensor S1 may be disposed at the end portion of the first pipe L1, the second sensor S2 may be disposed at the end portion of the second pipe L2, and the third sensor S3 may be disposed at the end portion of the main pipe M.

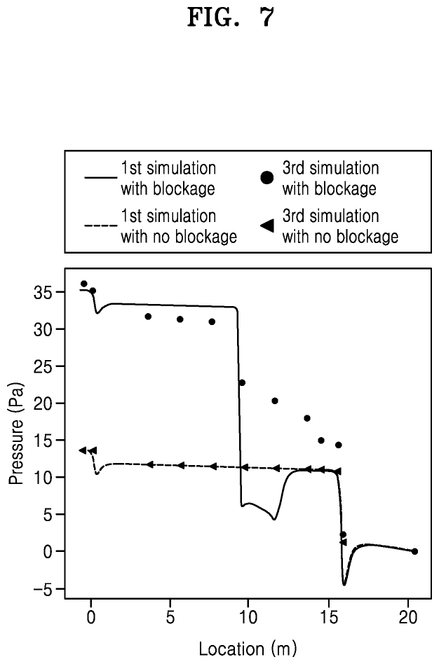

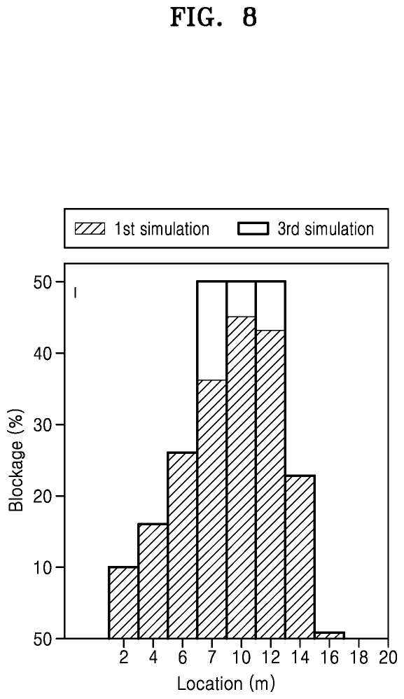

The pipe length a of the first pipe L1 was set to have the same value as the pipe length b of the second pipe L2. The pipe length a and the pipe length b were set to 33.6 m. The pipe length f of the main pipe M was set to 21 m. The first pipe L1 is connected to the main pipe M at a distance d from the point where the second pipe L2 is connected to the main pipe M. The distance d was set to 15.6 m. The second pipe L2 is connected to the main pipe M at a distance e distance from the end portion of the main pipe M. The distance e was set to 0.6 m. The results of fluid analysis performed on the pipe of FIG. 6 will be described with reference to FIGS. 7 and 8.

FIG. 7 is a graph showing the consistency of pressure predicted by the pipe blockage prediction method for the pipe of FIG. 5. Descriptions already provided above of FIGS. 1 to 6 are briefly given or omitted.

Referring to FIG. 7, the horizontal axis indicates a location within the main pipe M, and the vertical axis indicates pressure predicted at each location. The unit of the horizontal axis may be m, and the unit of the vertical axis may be Pa. On the graph, the solid line is the result of displaying the first simulation model for the case where there is pipe blockage, and the dotted line is the result of displaying the first simulation model for the case where there is no pipe blockage. A circle indicates a result of displaying the third simulation model for the case where there is pipe blockage, and a triangle mark indicates a result of displaying the third simulation model for a case where there is no pipe blockage. Here, with respect to the virtual pipe of FIG. 6, the flow of the fluid in the pipe was assumed through the first simulation model, and the flow of the fluid in the pipe was predicted through the third simulation model.

When comparing the case where there is pipe blockage and the case where there is no pipe blockage, it may be seen that when there is pipe blockage, the dotted line and the triangle mark generally coincide. Also, in the case where there was no blockage of the pipe, the solid line and the circled mark were almost identical. Through this, it was found that the third simulation model predicted the pressure of the fluid flowing in the pipe close to the pressure of the real fluid.

FIG. 8 is a graph showing the consistency of pipe blockage predicted by the pipe blockage prediction method for the pipe of FIG. 5.

Referring to FIG. 8, the graph is set as a case in which the pipe of FIG. 5 is blocked, and shows the results of pipe blockage of the first simulation model and pipe blockage of the third simulation model. The horizontal axis of the graph indicates the location in the main pipe M, and the vertical axis indicates the predicted pipe blockage at each location. The unit of the horizontal axis is m, and the unit of the vertical axis is percentage.

A bar graph indicated by hatching on the graph indicates a first simulation model, and a bar graph indicated by a thick solid line indicates a third simulation model. Looking at the graph, it may be seen that the first simulation model and the third simulation model coincide at the 2 m point, 4 m point, 6 m point, 14 m point and 16 m point from the end portion of the main pipe M. The pipe blockage of the third simulation model was higher than that of the first simulation model at the 7 m point, 10 m point, and 12 m point from the end portion of the main pipe M. However, the difference between the pipe blockage of the first simulation model and the pipe blockage of the third simulation model is within 15%, showing a generally consistent tendency.

Referring to FIGS. 7 and 8, the pipe pressure and pipe blockage predicted by the third simulation model mostly coincide with the first simulation model assuming an actual phenomenon, and it was found that the prediction accuracy was high.

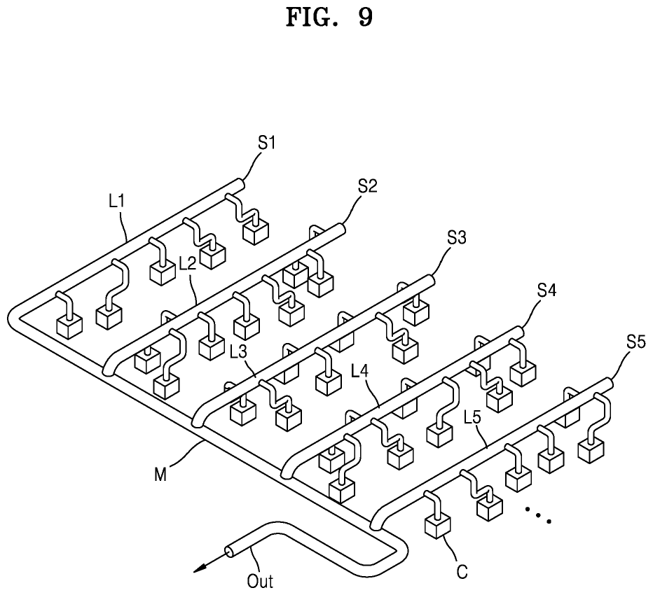

FIG. 9 is a diagram illustrating a plurality of pipes according to embodiments.

Referring to an embodiment of FIG. 9, the number of pipes and chambers is greater than that of the pipe of FIG. 6. The plurality of pipes may include a first pipe L1, a second pipe L2, a third pipe L3, a fourth pipe L4, a fifth pipe L5 . . . a fourteenth pipe (not shown), and a main pipe M. The plurality of chambers C are connected to the first pipe L1, the second pipe L2, the third pipe L3, the fourth pipe L4, the fifth pipe L5 . . . the fourteenth pipe (not shown), and the main pipe M. After the semiconductor process is performed in the chamber C, the fluid may be introduced into the plurality of pipes. In addition, a plurality of sensors (e.g., a first sensor S1, a second sensor S2, a third sensor S3, a fourth sensor S4, and a fifth sensor S5 . . . a fourteenth sensor (not shown)) may be disposed at the end portion of the plurality of pipes.

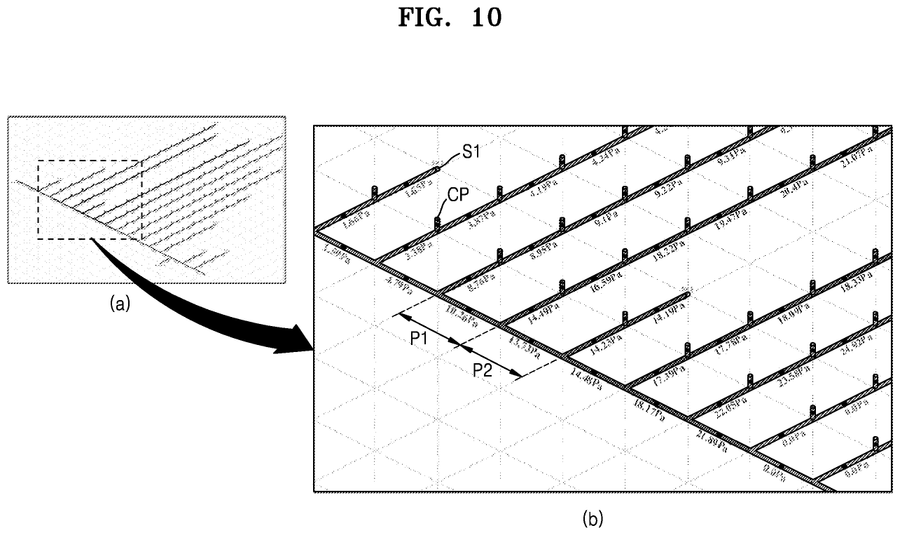

Although not all pipes are shown in FIG. 9, the number of pipes of the embodiment may be fifteen. The number of pipes in the embodiment may include fourteen lateral pipes and one main pipe. All of the fluid flowing in the lateral pipe flows into the main pipe. The pipe blockage prediction method of the example embodiment was performed on the pipe of FIG. 9, and the flow rate analysis map is shown in FIGS. 10 to 12.

FIGS. 10 to 12 are diagrams illustrating a fluid analysis map for the pipe of FIG. 8.

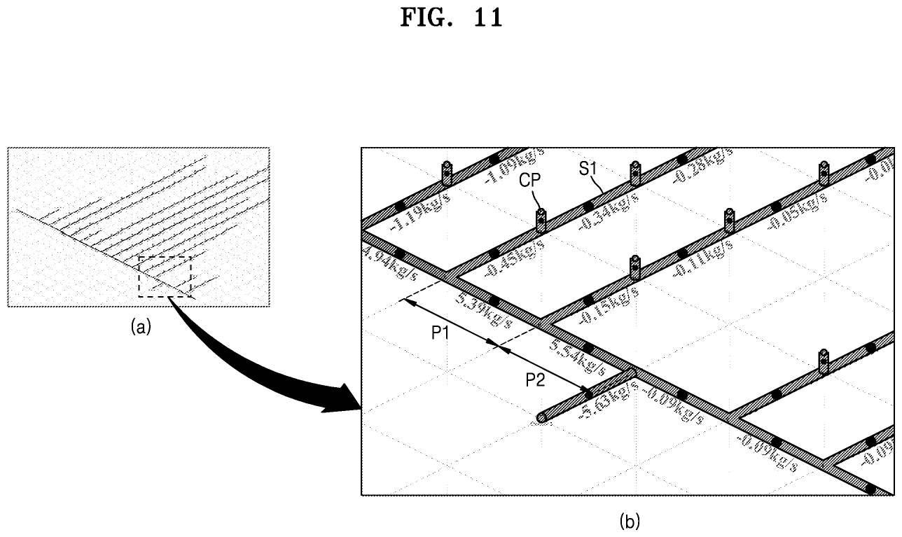

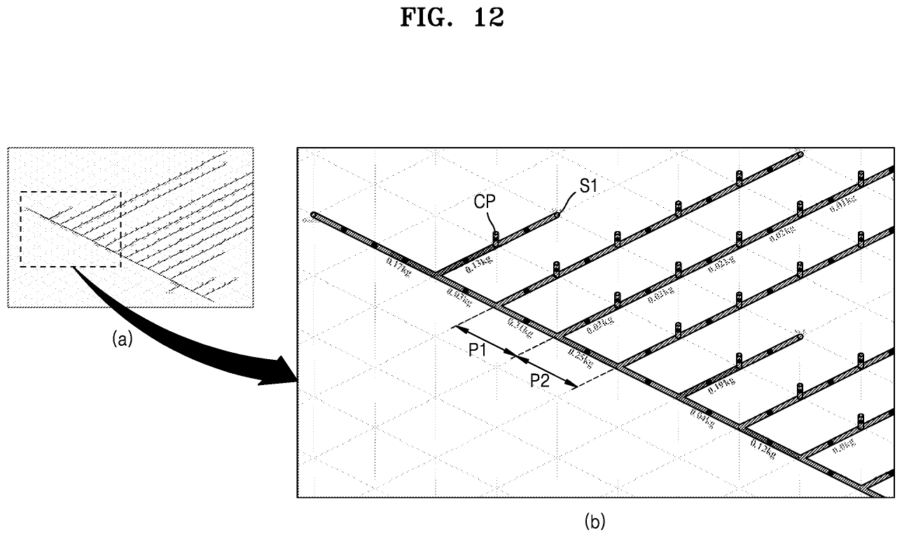

FIG. 10 shows a flow analysis map a and a partial enlarged view b showing the pressure predicted by the third simulation model, FIG. 11 shows a flow analysis map a and a partial enlarged view b indicating the flow rate of the fluid predicted by the third simulation model, and FIG. 12 shows a flow analysis map a and a partial enlarged view b indicating the amount of slurry predicted by the third simulation model. Here, each flow analysis map of FIGS. 10 to 12 is a contour image. CP indicated in FIGS. 10 to 12 indicates a pipe through which a fluid is introduced from the chamber.

Referring to FIG. 10, looking at a plurality of pipes in the enlarged view b of a portion of the flow analysis map a, section pressures for each of sections (e.g., P1 and P2) of a plurality of pipes analyzed by the third simulation model are indicated. In the pipe corresponding to the main pipe M, the pressure of the first section was 10.26 Pa and the pressure of the second section was 13.73 Pa. In each section of the pipe, sections indicated in black color indicate relatively high pressure, and sections indicated in light gray indicate relatively low pressure.

As shown in the flow analysis map a, the first sensor S1 is disposed on the end portion of the pipe, but may measure only the pressure of the end portion of the pipe and may predict the pressure for each section of each pipe through the pipe blockage prediction method of the example embodiment. In addition, as shown in the fluid analysis map a, it is possible to easily determine the flow of the fluid based on the pressure for each section displayed.

Referring to FIG. 11, looking at a plurality of pipes in the enlarged view b of a portion of the flow analysis map a, the flow rate of fluid for each of sections (e.g., P1 and P2) of a plurality of pipes analyzed by the third simulation model are indicated. The flow rate of the first section P1 was predicted to be 5.39 kg/s, and the flow rate of the second section P2 was predicted to be 5.54 kg/s.

The pressure of the main pipe including the first section P1 and the second section P2 showed that the flow rate of the fluid was relatively higher than that of the lateral pipe. As shown in the fluid analysis map a, the flow of the fluid may be easily determined based on the flow rate of the fluid for each section displayed.

Referring to FIG. 12, looking at a plurality of pipes in the enlarged view b of a portion of the flow analysis map a, the amount of slurry for each of sections (e.g., P1 and P2) of a plurality of pipes analyzed by the third simulation model are indicated. Here, the amount of slurry may be predicted using the predicted pipe diameter of the third simulation model. For example, the amount of the slurry may be predicted using a difference in the diameter of the predicted pipe from the diameter of the existing pipe, the density of the slurry formed by the fluid, and the like. The amount of slurry in the first section P1 is 0.31 kg, and the amount of slurry in the second section P2 is 0.25 kg. In each section of the pipe, sections indicated in a color close to black indicate a relatively high amount of slurry, and sections indicated in light gray indicate a relatively low amount of slurry.

The pressure of the main pipe including the first section P1 and the second section P2 showed that the flow rate of the fluid was relatively higher than that of the lateral pipe. As shown in the fluid analysis map a, the flow of the fluid may be easily determined based on the flow rate of the fluid for each section displayed. Pipe blockage may be predicted through the amount of slurry indicated for each section. In addition, maintenance may be performed on some pipes rather than the entire pipe through the amount of slurry or predicted pipe blockage.

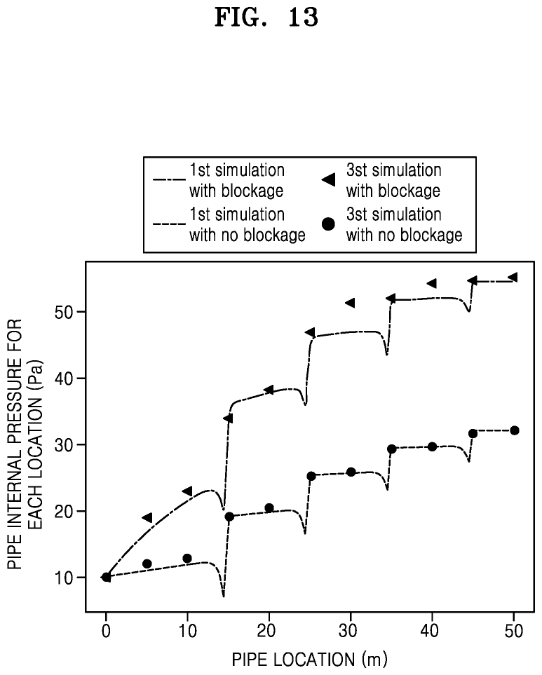

FIG. 13 is a graph showing the consistency of pressure predicted by the pipe blockage prediction method for a plurality of pipes of FIG. 9. Descriptions already provided above of FIGS. 1 to 6 are briefly given or omitted.

Referring to FIG. 13, the horizontal axis indicates a location within the main pipe M, and the vertical axis indicates pressure predicted at each location. The unit of the horizontal axis may be m, and the unit of the vertical axis may be Pa. On the graph, the dashed-dotted line is the result of displaying the first simulation model for the case where there is pipe blockage, and the dotted line is the result of displaying the first simulation model for the case where there is no pipe blockage. A circle is the result of displaying the third simulation model for the case where there is no pipe blockage, and a triangle mark is the result of displaying the third simulation model for the case where the pipe blockage is present. Here, with respect to the virtual pipe of FIG. 6, the flow of the fluid in the pipe was assumed through the first simulation model, and the flow of the fluid in the pipe was predicted through the third simulation model.

Comparing the case with pipe blockage and the case without pipe blockage, it may be seen that in case of pipe blockage, the dashed-dotted line and the triangle mark generally coincide. Also, in the case of no pipe blockage, it was generally consistent with the dotted line and circled marks. Through this, it was found that the third simulation model predicting the pressure of the plurality of pipes closely predicts the pressure of the actual fluid.

While has aspects of example embodiments have been particularly shown and described, it will be understood that various changes in form and details may be made therein without departing from the spirit and scope of the following claims.

What is claimed is:

1. A pipe blockage prediction method comprising:
generating a first simulation model by performing a first simulation based on pipe information and fluid information comprising a flow rate and pressure of a fluid in a pipe;
generating a second simulation model by performing a second simulation that is different from the first simulation, based on the pipe information and the fluid information;
generating a third simulation model through machine learning, based on the first simulation model and the second simulation model; and
predicting pipe blockage for each of a plurality of sections of the pipe based on the third simulation model.

2. The pipe blockage prediction method of claim 1, wherein the first simulation generates a first pressure value of the fluid in the pipe using a three-dimensional computational fluid dynamics (CFD) analysis method.

3. The pipe blockage prediction method of claim 1, wherein the second simulation generates a second pressure value based on a Darcy-Weisbach equation.

4. The pipe blockage prediction method of claim 1, wherein the generating of the second simulation model comprises:
calculating a plurality of section pressures for each section of the pipe;
generating a second pressure value for an end portion of the pipe based on the plurality of section pressures; and
generating a second simulation model for predicting the plurality of section pressures and the second pressure value.

5. The pipe blockage prediction method of claim 1, wherein the generating of the third simulation model comprises predicting a diameter for each of the plurality of sections of the pipe using an optimizer based on the first simulation model and the second simulation model.

6. The pipe blockage prediction method of claim 5, wherein the optimizer comprises a stochastic gradient descent (SGD) algorithm.

7. The pipe blockage prediction method of claim 1, wherein the generating of the third simulation model comprises generating a third preliminary simulation model that minimizes a difference between a first pressure value of the first simulation model and a second pressure value of the second simulation model.

8. The pipe blockage prediction method of claim 7, wherein the generating of the third simulation model comprises, after initial learning using the machine learning, obtaining a difference and a variance of the first simulation model and the second simulation model, and excluding the third preliminary simulation model exceeding a preset threshold based on at least one of the difference and the variance.

9. The pipe blockage prediction method of claim 8, wherein the generating of the third simulation model further comprises determining whether the third preliminary simulation model satisfies a set condition, and
wherein, when the set condition is satisfied, the third preliminary simulation model is selected as the third simulation model.

10. The pipe blockage prediction method of claim 1, wherein the machine learning uses at least one of a neural network, a support vector machine (SVM), a multi-layer perception (MLP), and deep learning.

11. The pipe blockage prediction method of claim 1, wherein the third simulation model predicts a diameter, a model pressure, and a mass of a slurry for each of the plurality of sections.

12. A pipe blockage prediction method comprising:
generating a first pressure value for each of a plurality of pipes using a three-dimensional computational fluid dynamics (CFD) analysis method based on pipe information and fluid information;
generating a section pressure for each section of the plurality of pipes based on the pipe information and the fluid information;
generating a second pressure value of each of the plurality of pipes based on the section pressure;
generating a section diameter for each section of the plurality of pipes based on the first pressure value and the second pressure value;
setting the section diameter and the second pressure value as parameters, and generating a pipe prediction model through machine learning; and
generating a fluid analysis map in a three-dimensional drawing based on the pipe prediction model.

13. The pipe blockage prediction method of claim 12, wherein the generating of the section diameter comprises generating the section diameter by a stochastic gradient descent (SGD) algorithm.

14. The pipe blockage prediction method of claim 12, wherein the generating of the pipe prediction model comprises repeatedly generating a first diameter based on the section diameter, changing a second pressure value based on the first diameter to create a changed second pressure value, and generating a second diameter based on the changed second pressure value.

15. The pipe blockage prediction method of claim 14, wherein the generating of the pipe prediction model comprises generating the pipe prediction model when a difference between the first pressure value and the changed second pressure value is less than or equal to a preset threshold value.

16. The pipe blockage prediction method of claim 12, wherein the fluid analysis map comprises a pipe diameter and a pipe pressure for each section of each of the plurality of pipes.

17. The pipe blockage prediction method of claim 12, wherein the first pressure value is based on a measurement by pressure sensors disposed at each end of the plurality of pipes.

18. A pipe blockage prediction method comprising:
generating a first simulation model by performing a first simulation based on pipe information and fluid information comprising flow rate information;
obtaining a second simulation model by performing a second simulation that is different from the first simulation on the pipe information and the fluid information;
generating a third simulation model using a machine learning model based on the first simulation model and the second simulation model;
generating a fluid analysis map displaying a pipe diameter and a pipe pressure for each section of the plurality of pipes in a three-dimensional drawing using the third simulation model; and
predicting pipe blockage for each section of the plurality of pipes based on the fluid analysis map,
wherein the first simulation model predicts a first pressure value corresponding to pipe pressure in an end portion of each of the plurality of pipes,
wherein the second simulation model predicts a second pressure value corresponding to a section pressure for each section of the plurality of pipes and a pressure of the end portion of each of the plurality of pipes,
wherein, when a difference between the first pressure value and the second pressure value is less than or equal to a preset threshold, the third simulation model is generated.

19. The pipe blockage prediction method of claim 18, wherein the predicting of the pipe blockage for each section of the plurality of pipes comprises determining a pipe blockage for a particular section of the each section, if the pipe diameter for the particular section is 70 percent or less of an unblocked diameter of the pipe where a slurry is not formed.

20. The pipe blockage prediction method of claim 18, wherein the first simulation generates the first simulation model including the first pressure value using a three-dimensional computational fluid dynamics analysis method,
wherein the second simulation generates the second simulation model including the second pressure value based on a Darcy-Weisbach equation, and
wherein a third simulation generates the third simulation model by calculating the pipe diameter for each section of the plurality of pipes based on the first pressure value and the second pressure value.
